(19) United States
(12) Patent Application Publication
(10) Pub. No.: US 2017/0275022 A1
(43) Pub. Date: Sep. 28, 2017

(54) CRASH DEBRIS FIELD LOCATOR USING MINIATURE REDUNDANT TAGS

(71) Applicant: Lawrence J. Karr, Santa Monica, CA (US)

(72) Inventor: Lawrence J. Karr, Santa Monica, CA (US)

(21) Appl. No.: 15/466,275

(22) Filed: Mar. 22, 2017

Related U.S. Application Data
(60) Provisional application No. 62/312,137, filed on Mar. 23, 2016.

(51) Int. Cl. B64D 47/06; G06K 7/10

(52) U.S. Cl. CPC B64D 47/06; G06K 7/10366; G01S 19/14

(57) ABSTRACT

A system for locating a debris field resulting from a plane crash comprises a plurality of low-power, battery operated electronic transponder tags, and at least one locator operative to the interrogate the tags to determine the location thereof. The tags are placed on or in an airplane in multiple locations, thereby enabling the locator to determine the location of a debris field in the event of a crash. The locator, which may be airborne, preferably reports tag positions for map display. The tags may be hermetically sealed to prevent water infiltration, and may be triggered to an active state in response to a large acceleration or always in an ON state. Tags placed on or in the airplane may be mounted in a manner to intentionally detach. The tags may further include a barometric pressure sensor, a shock sensor and/or an accurate time base to record the time of a crash.

### REFERENCE TO RELATED APPLICATIONS

This application claims priority to U.S. Provisional Patent Application Ser. No. 62/312,137, filed Mar. 23, 2017, the entire content of which is incorporated herein by reference.

### FIELD OF THE INVENTION

This invention related generally to tagging, tracking and locating systems and, in particular, to a system and method for quickly locating the debris from airliner crashes independently of other techniques, and at minimal cost.

### BACKGROUND OF THE INVENTION

In a recent airliner incident, the paradigm of survivable flight recorder/cockpit voice recorder failed. MH370 is a case, where, for some reason(s), normal tracking systems were off line, and the only signals received from the aircraft were engine status reports via satellite. The crash site is unknown to this date, long after the flight recorder's beacon batteries were exhausted. There is an outstanding need for a system and method for locating airliner crash debris to independently ascertain the crash site if not the cause(s) of the crash.

### SUMMARY OF THE INVENTION

This invention provides a system and method for quickly locating the debris from airliner crashes independently of other techniques, and at minimal cost. The system also potentially offers some information regarding airframe failure events.

A system for locating a debris field resulting from a plane crash in accordance with the invention comprises a plurality of low-power, battery operated electronic transponder tags, and at least one locator operative to the interrogate the tags to determine the location thereof. In accordance with the invention, the tags are placed on or in an airplane in multiple locations, thereby enabling the locator to determine the location of a debris field in the event of a crash. The locator, which may be airborne, preferably reports tag positions as KML or similar information for map display.

In preferred embodiments, the tags are hermetically sealed to prevent water infiltration, and may be triggered to an active state in response to a large acceleration. In the event of impact causing structural disintegration, the tags placed on or in the airplane are mounted in a manner to intentionally detach. The tags are preferably always in an active state, and may include a barometric pressure sensor, a shock sensor and/or an accurate time base to record the time of a crash.

### BRIEF DESCRIPTION OF THE DRAWINGS

FIG. 1 is an overview drawing showing an airborne locator and a plurality of tags; and

FIG. 2 is a highly simplified block diagram of a locator module and a transponder tag.

### DETAILED DESCRIPTION OF THE INVENTION

To solve existing challenges associated with airliner crash location, this invention provides a system and method for quickly locating the debris from an airliner crash independently of other techniques, and at minimal cost. The system also potentially offers some information regarding airframe failure events.

Santa Monica Semiconductor LLC (Santa Monica, Calif.) designs tagging tracking and locating (TTL) systems for US Government applications. These TTL systems are comprised of miniature, low power transponders (tags), and larger airborne transponders (locators). The patented system can accurately locate tags with a single round-trip transaction. The operating principle is round-trip time-of-flight combined with round-trip Doppler. This combination achieves precise tag location, subject to a two-fold ambiguity. The ambiguity is quickly resolved with a second transaction or with an angle-of arrival (AOA) sensing antenna. The distance measurement accuracy of our system is about 1 meter RMS, and our round-trip Doppler error is about 1.5 cm/second. Tags and locators are described in U.S. Pat. Nos. 7,573,381, 7,592,918, 7,646,330, 7,791,470, 7,864,045, 7,917,155, 7,936,271, 8,258,923, RE43,740, 8,384,584, 8,487,756, RE44,526, 8,583,145, RE45,061, 9,042,916, and pending U.S. Application Serial No. 20150201308, with the entire content of each of these references being incorporated herein.

At an airspeed of 180 kph and including GPS velocity error, we obtain a 1.5 milliradian pointing error. At a 100 km distance, tag positions become known to within 150 meters from a slow airplane. With a 600 kph aircraft, the locus of position from a single ping would be a half milliradian segment of arc with a distance uncertainty of about 1 meter. Our standard single chip tag operates for one year from a 200 mah Lithium Polymer battery, with a ten second reporting latency. The average current drain is about 20 microamperes, and this can be further reduced. Our tag transceiver emits no signal until correctly queried with its unique set of spreading codes.

With our standard airborne locator over the metropolitan Los Angeles area, the tag reporting range is about 100 km. Tag output power is +17 dbm, which can be increased for longer range operation. The range limitation in normal operation in the CONUS is manmade noise emitted from population centers. This noise impacts the ground to air path rather than the air to ground path, since an airborne locator receives noise sources essentially from the horizon.

The present laboratory performance of our standard TTL system is that it operates with a path loss of 150 db. This corresponds to a free space range of about 600 km at our 32 cm operating wavelength.

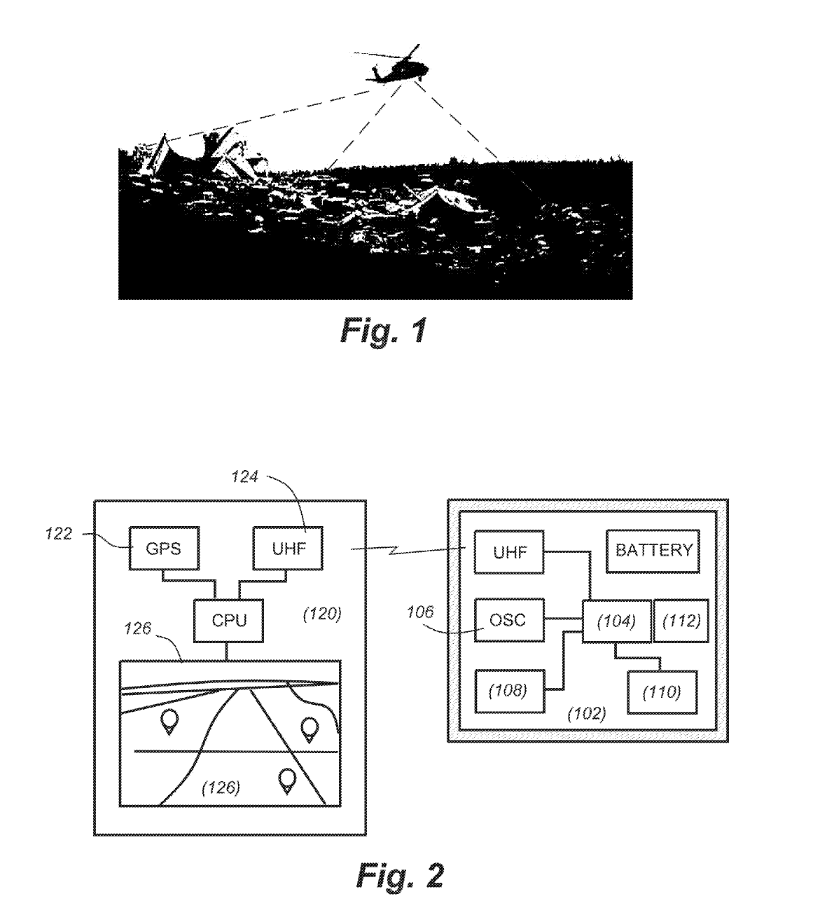

The idea disclosed herein involves placement of these tags in an airplane in multiple locations where impact would cause structural disintegration, and if they were not strongly fastened to the aircraft structure, then they would likely separate from pieces of the wreckage. Our present tags are quite small (a printed circuit assembly measuring 30 mm*18 mm*3 mm), and can therefore withstand rather large shock loads. If these cards were to be encased in a low density enclosure, coated to prevent water infiltration, they could withstand ocean impact. FIG. 1 is a simplified drawing of a crash debris field with several scattered transponder tags in communication with an airborne locator.

These tags could be triggered to an active state by a large acceleration, or simply left “on.” If a two ampere hour high energy density primary battery were to be used with each tag, the tag would stay active for upwards of ten years. Such a battery would weigh about 22 grams. Since these tags would be independent of all aircraft systems including power, they would only minimally impact other systems. As only a single surviving tag would be required to mark a debris field, it is unnecessary to be extremely concerned with the unconditional survival of all tags. If multiple tags survive, they will respond to the same query, with precise time delays between responses, so that independent measurements can be made of tag positions. If these tags were to be fitted with barometric pressure and shock sensors, then recordings could be made of any major disturbances.

FIG. 2 is a block diagram of a tag and locator applicable to the invention. The current Santa Monica Semiconductor tags 102 are built around a single mixed signal custom chip 104, designed in house. The airborne locators 120 that interrogate these tags are contained in a 300 gram package, and require about 2.5 watts average power when activated, and connect to a GPS antenna 122 and a UHF blade antenna 124. The airborne locator reports tag positions as KML (Keyhole Markup Langauge) or similar information for map display 126.

There are other necessary components in the SMS tags. One of the most important parts, since it determines range, accuracy, and longer term timing, is a highly stable temperature-compensated crystal oscillator (TCXO) 106. In this application, we will be concerned with frequency stability as a function of temperature and over long time spans (i.e., possibly ten years of aging). Our present devices are not sufficiently stable to maintain system performance margins for ten years or more. The required overall stability is 0.5 ppm over time and temperature. The stability requirement derives from tag coherent signal integration time.

With an integration time of 1 millisecond, and with a 1000 Hz frequency difference, all possible signal phases will occur, causing a frequency response null. With a 750 microsecond integration time at a frequency offset of 500 Hz (0.5 ppm), the sin(x)/x effect will about 2 decibels, which is acceptable. In addition, tiny barometric pressure 108 and shock sensors 110 are very useful in capturing incident data. Of course, TCXOs will not agree about exact timing after a span of years, but if event times are captured with time marks, then by examining each tag, one could establish relative event timing quite precisely from post-crash analysis.

For instance, if tags are recovered 1 week post incident, and if the relative frequencies of those tags can be established to 1 part in 10̂8, then the relative time uncertainty between pre-detachment recorded events would be less than 10 milliseconds, which is relatively fine-grained timing. In this way, a distributed network of simple sensor tags would be able to record relative and absolute event times in memory 112 for various pieces of a debris field, as well as marking the debris field.

1. A system for locating a debris field resulting from a plane crash, comprising:
a plurality of low-power, battery operated electronic transponder tags;
at least one locator operative to the interrogate the tags to determine the location thereof; and
wherein the tags are placed on or in an airplane in multiple locations, thereby enabling the locator to determine the location of a debris field in the event of a crash.

2. The system of claim 1, wherein the locator is airborne.

3. The system of claim 1, wherein the tags are hermetically sealed to prevent water infiltration.

4. The system of claim 1, wherein the tags are triggered to an active state by a large acceleration.

5. The system of claim 1, wherein the tags are always in an active state.

6. The system of claim 1, wherein the airborne locator reports tag positions as KML or similar information for map display.

7. The system of claim 1, including a tag with a barometric pressure sensor.

8. The system of claim 1, including a tag with a shock sensor.

9. The system of claim 1, including a tag with an accurate time base to record the time of a crash.

10. The system of claim 1 wherein, in the event of impact causing structural disintegration, the tags placed on or in the airplane are mounted in a manner to intentionally detach.
